(19) United States
(12) Patent Application Publication
(10) Pub. No.: US 2019/0299371 A1
(43) Pub. Date: Oct. 3, 2019

(54) Pipe wrench structure with secure positioning function

(71) Applicant: Shwu-Ruu Chern, Taichung (TW)

(72) Inventor: Shwu-Ruu Chern, Taichung (TW)

(21) Appl. No.: 15/939,159

(22) Filed: Mar. 28, 2018

(51) Int. Cl. B25B 13/50

(52) U.S. Cl. CPC B25B 13/505; B25B 13/36

(57) ABSTRACT

A pipe wrench structure with a secure positioning function includes a main body, an engaging portion including a pivot point, an upper jaw and a lower jaw for performing an opening/closing operation, a pipe being placed between the upper and lower jaws while clamping the pipe; an elastic restoring member, installed to the upper and lower jaws and configured to be corresponsive to the pivot point, and provided for providing a pressing force to the upper jaw; an auxiliary ratchet surface, disposed at the lower jaw; an arc ratchet surface, disposed on an inner side of the upper jaw opposite to the lower jaw, and being in form of concave arc surface without an included angle, and the curvature of the arc ratchet surface being greater than the external periphery of the pipe.

### FIELD OF THE INVENTION

The present invention relates to a pipe wrench, in particular to a novel pipe wrench structure with a secure positioning function.

### BACKGROUND OF THE INVENTION

In general, a general wrench used for clamping and rotating a pipe (such as a water pipe, a gas pipe, etc.) may slip off the pipe easily and fail to clamp the pipe securely due to the shape of the pipe, so that related manufacturers make improvements to overcome the slipping problem by developing a pipe wrench.

With reference to FIGS. 7 and 8 for a conventional pipe wrench 10, the conventional pipe wrench 10 comprises a main body 11, and an upper jaw 13 and a lower jaw 14 disposed at an end of the main body 11 and capable of performing an opening or closing operation, and both upper and lower jaws 13, 14 have a plurality of ratchets 15 in form of teeth and arranged in surfaces on opposite inner sides of the upper and lower jaws 13, 14 respectively. When a pipe A is clamped by the pipe wrench 10, the ratchets 15 increase the clamping resistance to facilitate rotating the pipe A in order to remove or secure the pipe A.

Although the conventional pipe wrench 10 is convenient to use, yet a secure engagement cannot be achieved. When the pipe A is clamped and rotated, the pipe wrench 10 may slip off the pipe A easily. Since most of the conventional pipe wrench 10 come with the ratchets 15 of the upper jaw 13 which are designed and arranged with an included angle and a “ [symbol] ” shaped surface, so that when the pipe A is clamped, the external periphery of the pipe A touches two ratchets 15 of the upper jaw 13 first. Now, the position of the pipe A is determined, so that not the whole external periphery of the pipe A can be aligned precisely with the tip of the ratchets 15 of the lower jaw 14. If the tangential arc of the pipe A is situated precisely between two ratchets 15 of the upper jaw 13, then the pipe A will be able to be engaged securely, and thus resulting in an idling rotation and a failure of applying force. The pipe wrench 10 still may slip off the pipe A easily.

### SUMMARY OF THE INVENTION

Therefore, it is a primary objective of the present invention to overcome the aforementioned drawbacks of the conventional wrench by providing a novel and practical pipe wrench structure with a secure positioning function for clamping a pipe.

To achieve the aforementioned and other objectives, the present invention provides a pipe wrench structure comprising: an engaging portion, including an upper jaw, a lower jaw, and a pivot point for pivotally coupling the upper and lower jaws to perform an operation of opening and closing the upper and lower jaws, and the pipe being placed between the upper and lower jaws while clamping the pipe; an elastic restoring member, installed to the upper and lower jaws and disposed at a position corresponsive to the pivot point, for providing a pressing force to the upper jaw; an auxiliary ratchet surface, disposed at the lower jaw; an arc ratchet surface, disposed on an inner side of the upper jaw opposite to the lower jaw, wherein the arc ratchet surface is in form of a concave arc surface without an included angle, and the curvature of the arc ratchet surface is greater than the external periphery of the pipe.

Compared with the prior art, the unique and novel structure of the present invention having the special type of arc ratchet surface and using the elastic restoring member to provide a pressing force to the upper jaw can automatically find the pipe and the auxiliary ratchet surface, and the tip of any tooth of the arc ratchet surface is situated at a securely engaged status, so that the positioning for engagement can be adjusted quickly regardless of the size of the pipe, and the slipping of the pipe wrench can be avoided. Obviously, the invention improves over the prior art.

### BRIEF DESCRIPTION OF THE DRAWINGS

FIG. 1 is an exploded view of the present invention;

FIG. 2 is a perspective view of the present invention;

FIG. 3 is a cross-sectional view of the whole structure of the present invention;

FIG. 4 is a schematic view of a clamping status of the present invention;

FIG. 5 is a schematic view of clamping a pipe in accordance with the present invention;

FIG. 6 is a schematic view of clamping another pipe in accordance with the present invention;

FIG. 7 is a schematic view of a conventional pipe wrench clamping a pipe; and

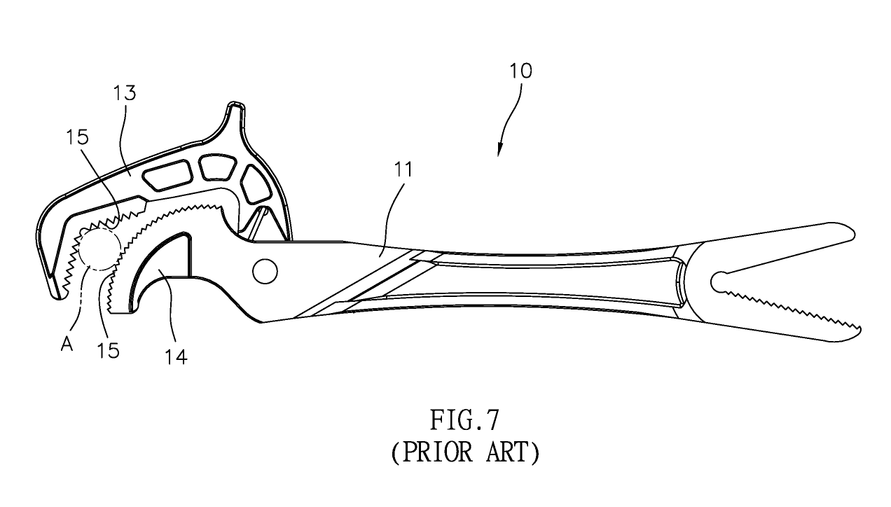

FIG. 8 is a schematic view of a conventional pipe wrench clamping another pipe.

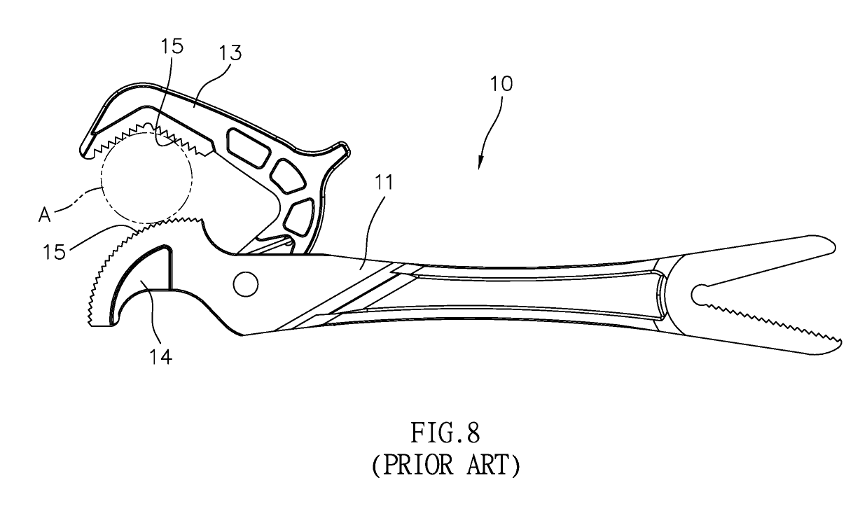

### DESCRIPTION OF THE PREFERRED EMBODIMENTS

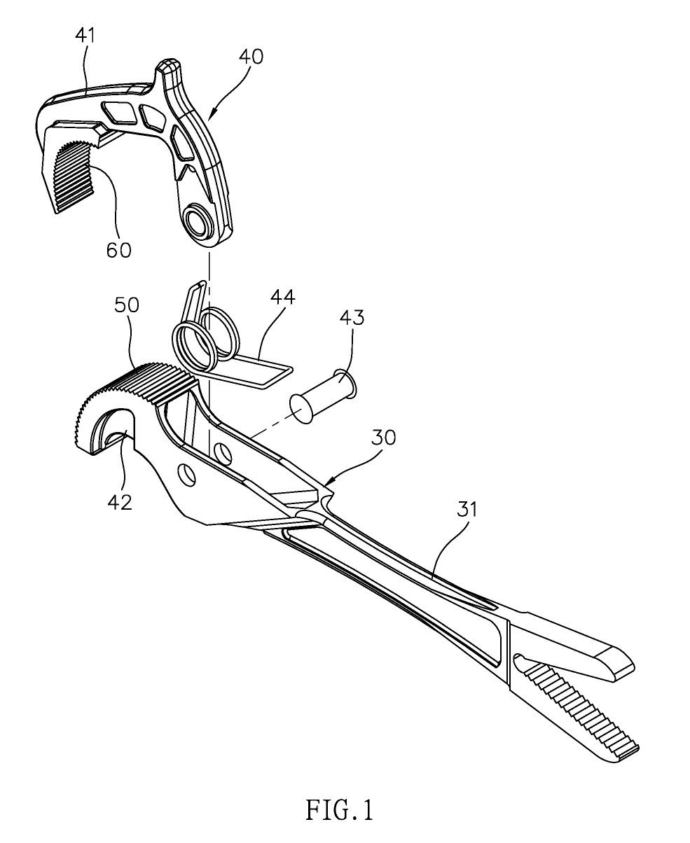

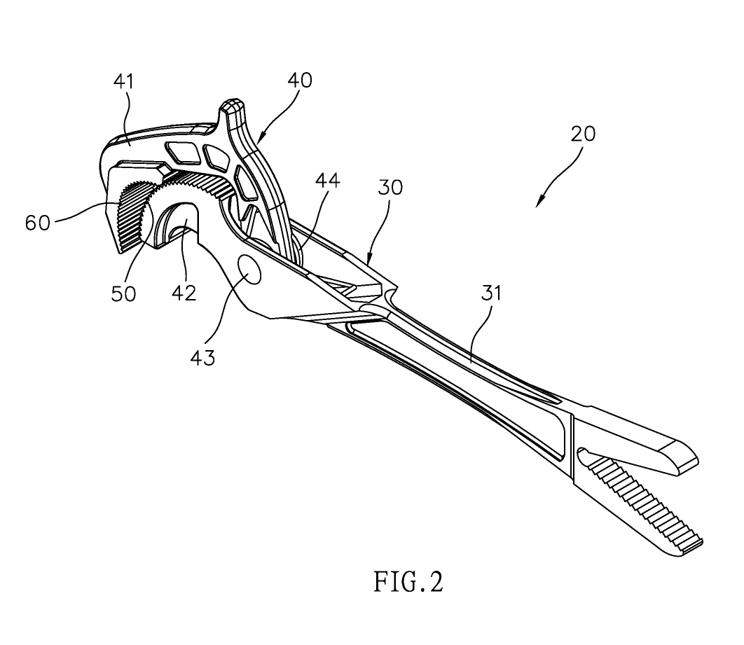

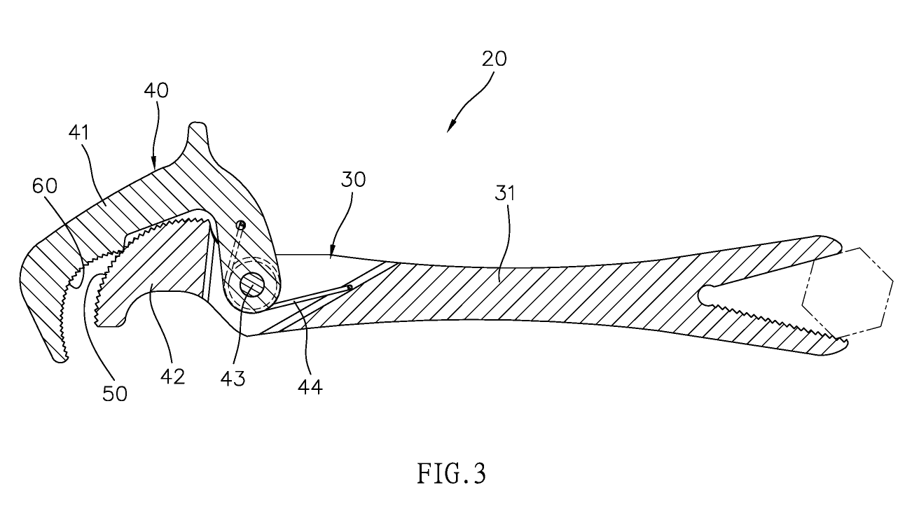

With reference to FIGS. 1 to 4 for a pipe wrench structure with a secure positioning function 20 in accordance with a preferred embodiment of the present invention, the embodiment is provided for the purpose of illustrating the present invention only, but not intended for limiting the scope of the invention.

The pipe wrench structure 20 provided for clamping a pipe B comprises: a main body 30, being in form of an extending body and having a grip portion 31; an engaging portion 40, disposed at an end of the main body 30, including an upper jaw 41, a lower jaw 42, and a pivot point 43 for pivotally coupling the upper and lower jaws 41, 42 to perform an operation of opening and closing the upper and lower jaws 41, 42, and the pipe B being placed between the upper and lower jaws 41, 42 while clamping the pipe B; an elastic restoring member 44, installed to the upper and lower jaws 41, 42 and disposed at a position corresponsive to the pivot point 43, for providing a pressing force to the upper jaw 41; an auxiliary ratchet surface 50, disposed at the lower jaw 42; an arc ratchet surface 60, disposed on an inner side of the upper jaw 41 opposite to the lower jaw 42, and the arc ratchet surface 60 being in form of a concave arc surface without an included angle, and the curvature of the arc ratchet surface 60 being greater than the external periphery of the pipe B.

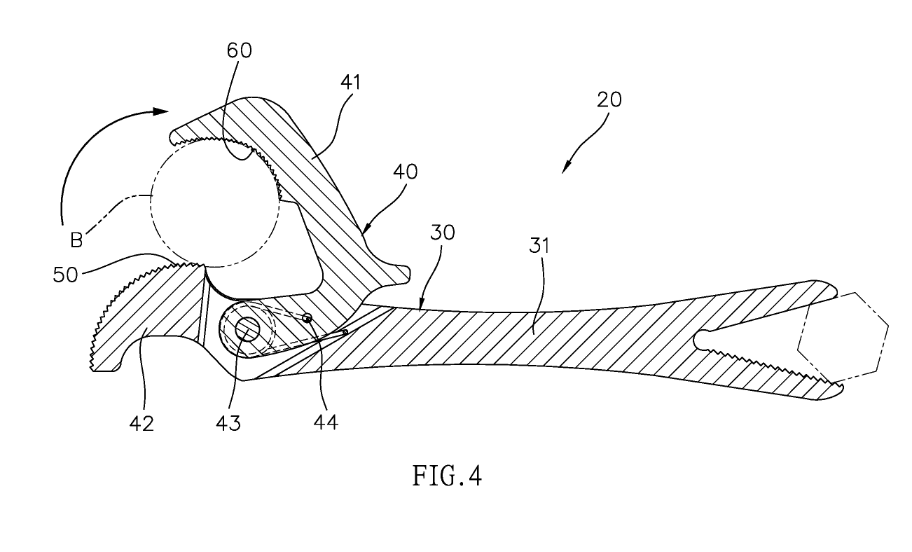

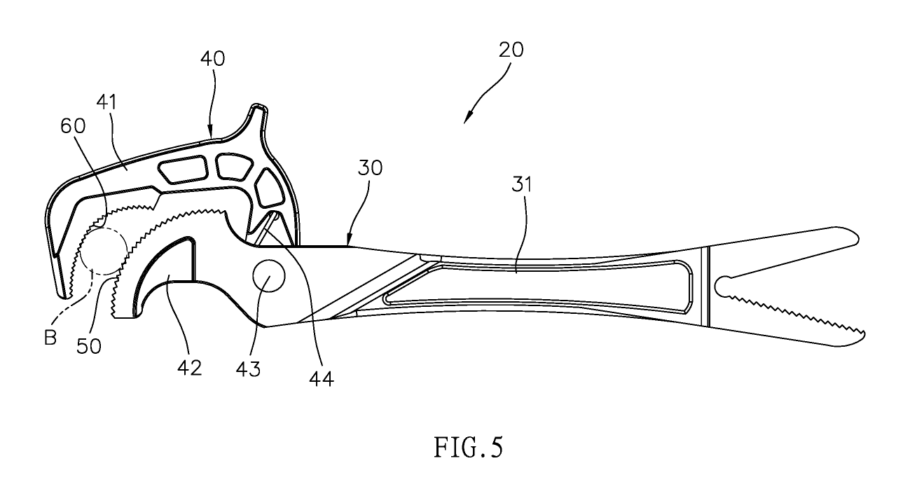

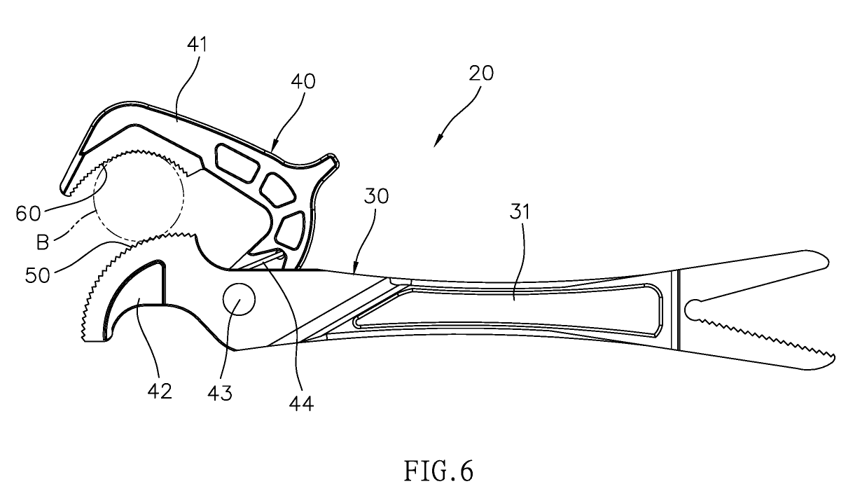

With reference to FIGS. 4 to 6, when a user remove or secure the pipe B, the elastic restoring member 44 provides a pressing force of the upper jaw 41, so that the pipe B and the auxiliary ratchet surface 50 can be found automatically, and force exertion position at the tip of any tooth of the arc ratchet surface 60 can be engaged securely. In the process of applying forces reciprocally, the best force exertion position for engaging the external periphery of the pipe B can be found automatically, so as to achieve the automatic adjustment and secure positioning effects. Regardless of the diameter of the pipe B (as shown in FIGS. 4 to 6), this structural design allows the pipe B to be engaged and positioned at the best position securely and quickly, without the issues of the prior art that fails to engage the pipe B and has the idling rotation or slipping problem.

The auxiliary ratchet surface 50 of the present invention may be a convex arc surface or a plane (wherein the figure just shows the convex arc surface as an example for illustrating the invention).

In summation, the present invention has the following effects:

The pipe wrench structure with a secure positioning function in accordance with the present invention makes use of the pressing force of the elastic restoring member 44 and the structural form of the arc ratchet surface 60 to improve over the prior art. Compared with the prior art, the present invention with the ratchets 15 arranged into a “ [symbol] ” shaped surface with an includes angle can achieve the effects of automatically adjusting the engaging position, providing a quick positioning for pipes of different sizes, and preventing the pipe wrench from slipping off the pipe.

While the invention has been described by means of specific embodiments, numerous modifications and variations could be made thereto by those skilled in the art without departing from the scope and spirit of the invention set forth in the claims.

What is claimed is:

1. A pipe wrench structure with a secure positioning function, for clamping a pipe, comprising:
a main body, having a grip portion;
an engaging portion, disposed at an end of the main body, including an upper jaw, a lower jaw, and a pivot point for pivotally coupling the upper and lower jaws to perform an operation of opening and closing the upper and lower jaws, and the pipe being placed between the upper and lower jaws while clamping the pipe;
an elastic restoring member, installed to the upper and lower jaws and disposed at a position corresponsive to the pivot point, for providing a pressing force to the upper jaw;
an auxiliary ratchet surface, disposed at the lower jaw;
an arc ratchet surface, disposed on an inner side of the upper jaw opposite to the lower jaw, and being in form of concave arc surface without an included angle, and the curvature of the arc ratchet surface being greater than the external periphery of the pipe, and when the pipe is clamped, the elastic restoring member providing a pressing force of the upper jaw and capable of finding the pipe and the auxiliary ratchet surface automatically, so that the tip of any tooth of the arc ratchet surface is situated at a relatively secure engaged status.

2. The pipe wrench structure with a secure positioning function according to claim 1, wherein the auxiliary ratchet surface is a plane or a convex arc surface.
